(19) United States
(12) Patent Application Publication
(10) Pub. No.: US 2024/0288984 A1
(43) Pub. Date: Aug. 29, 2024

(54) INTERACTION METHOD, DEVICE AND EQUIPMENT, AND STORAGE MEDIUM

(71) Applicant: Beijing Zitiao Network Technology Co., Ltd., Beijing (CN)

(72) Inventors: Fangjia CHEN, Beijing (CN); Yonghao ZHANG, Beijing (CN); Zhong WANG, Beijing (CN); Qianmin ZHANG, Beijing (CN)

(21) Appl. No.: 18/573,378

(22) PCT Filed: Aug. 12, 2022
(86) PCT No.: PCT/CN2022/111959

§ 371 Date: Dec. 21, 2023

(30) Foreign Application Priority Data
Aug. 13, 2021 (CN) 202110929328.1

(51) Int. Cl. G06F 3/0481

(52) U.S. Cl. CPC G06F 3/0481

(57) ABSTRACT

The embodiment of the invention discloses an interaction method, device and equipment, and a storage medium. A first user triggers an object adding operation aiming at a first object in a session interface for performing a conversation with one or more second users, then a client adds the first object in the session interface according to the object adding operation, the first object can be accessed by one or more second users, that is to say, after the first object is added in the session interface, the first user or the second user can directly and quickly access the first object on the session interface, the first object can be found without a chat record, and convenience is brought to the users.

### CROSS-REFERENCE TO RELATED APPLICATIONS

The present application claims the priority to Chinese Patent Application No. 202110929328.1, entitled “Interaction method, device and equipment, and storage medium” filed on Aug. 13, 2021, which is incorporated herein by reference in its entirety.

### TECHNICAL FIELD

The present application relates to the field of computers, and in particular, to an interaction method, device, equipment and storage medium.

### BACKGROUND

With the rapid development of Internet-related technologies, a user can communicate with other users through a variety of communication software. During the communication between the user and other users, the user or other users may often send documents, images, videos or web links to enrich contents of the communication.

When the user later wants to find documents, images, videos or web links sent during communication, the user needs to go through a chat record to find the relevant contents, and the process is relatively cumbersome for users.

### SUMMARY

In order to solve problems existing in the prior art, in embodiments of the present application are provided an interaction method, device, equipment and storage medium.

The embodiment of the application provides an interaction method, comprising:
receiving an object adding operation triggered by a first user in a session interface, wherein the session interface is an interface where the first user has a conversation with one or more second users; and
adding a first object in the session interface according to the object adding operation, wherein the first object is used to be accessed by the one or more second users.

The embodiment of the application also provides an interaction method, comprising:
receiving a sending operation of a first user sending a first object to one or more second users in a session interface, wherein the session interface is an interface where the first user has a conversation with one or more second users; and
adding the first object in an object folder label of the session interface according to the sending operation.

The embodiment of the application also provides an interaction device, comprising:
an object adding operation receiving unit, configured to receive an object adding operation triggered by a first user in a session interface, wherein the session interface is an interface where the first user has a conversation with one or more second users; and
a first object addition unit in the session interface, configured to add a first object in the session interface according to the object adding operation, wherein the first object is used to be accessed by the one or more second users.

The embodiment of the application also provides an interaction device, comprising:
a sending operation receiving unit, configured to receive a sending operation of a first user sending a first object to one or more second users in a session interface, wherein the session interface is an interface where the first user has a conversation with one or more second users; and
a first object addition unit in an object folder label, configured to add the first object in the object folder label of the session interface according to the sending operation.

The embodiment of the application also provides an interaction equipment, comprising: a processor and a memory;
wherein the memory is configured to store instructions; and
the processor is configured to execute the instructions in the memory to perform the method of the interactive method embodiment described above.

The embodiment of the application also provides a computer-readable storage medium, comprising instructions, wherein when the instructions are executed in a computer, the computer is enabled to execute the method of the interactive method embodiment described above.

The embodiment of the invention provides an interaction method, wherein a first user triggers an object adding operation aiming at a first object in a session interface for performing a conversation with one or more second users, then a client adds the first object in the session interface according to the object adding operation, the first object can be accessed by one or more second users, that is to say, after the first object is added in the session interface, the first user or the second user can directly and quickly access the first object on the session interface, the first object can be found without a chat record, and convenience is brought to the users.

### BRIEF DESCRIPTION OF DRAWINGS

In order to explain embodiments of the present application or technical solutions in the prior art more clearly, the accompanying drawings needed to be used in the description of the embodiments or the prior art will be briefly introduced below. Obviously, the accompanying drawings in the following description are only some embodiments recorded in the present application, and those skilled in the art can also obtain other accompanying drawings according to these accompanying drawings, without creative labor made.

FIG. 1 is a flow chart of an interaction method provided in an embodiment of the present application.

FIGS. 2-14 are schematic diagrams of display interfaces of a client side provided in an embodiment of the present application.

FIGS. 15-25 are schematic diagrams of display interfaces of another client side provided in an embodiment of the present application.

FIG. 26 is a flow chart of an interaction method provided in an embodiment of the present application.

FIGS. 27-30 are schematic diagrams of display interfaces of a client side provided in an embodiment of the present application.

FIG. 31 is a schematic diagram of a display interface of another client side provided in an embodiment of the present application;

FIG. 32 is a structural block diagram of an interaction device provided in an embodiment of the present application;

FIG. 33 is a structural block diagram of another interaction device provided in an embodiment of the present application;

FIG. 34 is a structural block diagram of an interaction equipment provided in an embodiment of the present application.

### DETAILED DESCRIPTION OF THE EMBODIMENTS

For those skilled in the art to better understand solutions of the present application, the technical solutions in embodiments of the present application will be clearly and completely described below in combination with the accompanying drawings in the embodiments of the present application. Obviously, the described embodiments are only part of the embodiments of the present application, but not all of them. All other embodiments obtained by those skilled in the art based on the embodiments in the present application, without creative labor made, fall within the protection scope of the present application.

As mentioned in the background art, during the communication between a user and other users, the user or other users may often send documents, images, videos or web links to enrich contents of the communication. When the user later wants to find documents, images, videos or web links sent during communication, the user needs to go through a chat record to find the relevant contents. Especially for documents or links that need to be accessed frequently, it is necessary to go through a chat record every time to determine what a user is looking for, which is cumbersome for users.

Based on this, the embodiment of the invention provides an interaction method, wherein a first user triggers an object adding operation aiming at a first object in a session interface for performing a conversation with one or more second users, then a client adds the first object in the session interface according to the object adding operation, the first object can be accessed by one or more second users, that is to say, after the first object is added in the session interface, the first user or the second user can directly and quickly access the first object on the session interface, the first object can be found without a chat record, and convenience is brought to the users.

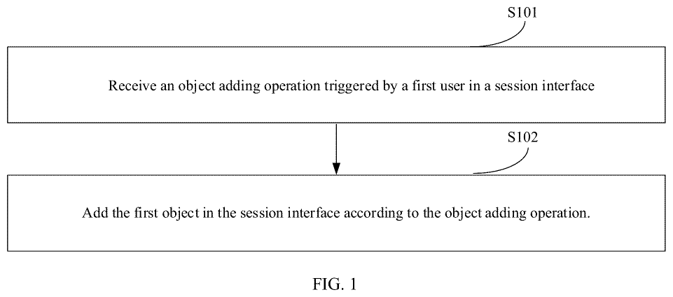

Refer to FIG. 1, which is a flowchart of an interaction method provided in an embodiment of the present application.

The interaction method provided in the embodiment of the present application is applied to a client side. Herein, the client side can be a terminal device, which is a hardware device that can communicate, such as a mobile phone, a tablet computer, or a personal computer (PC). The client side can also be a software client side used for communication. The interaction method provided in the following embodiment is introduced by using a software client side installed on a personal computer.

The interaction method provided in the embodiment includes the following steps.

S101: Receiving an object adding operation triggered by a first user in a session interface.

In embodiments of the present application, the first user is a user who communicates in the session interface of the client side. The session interface is an interface where the first user has a conversation with one or more second users through the client side. The conversation can be a voice conversation or a text conversation. In the session interface can be included merely the first user and one second user who have a separate one-to-one communication, and namely the session interface is a private chat message interface. In the session interface can also be included the first user and multiple second users, and namely the session interface can be a group chat message interface.

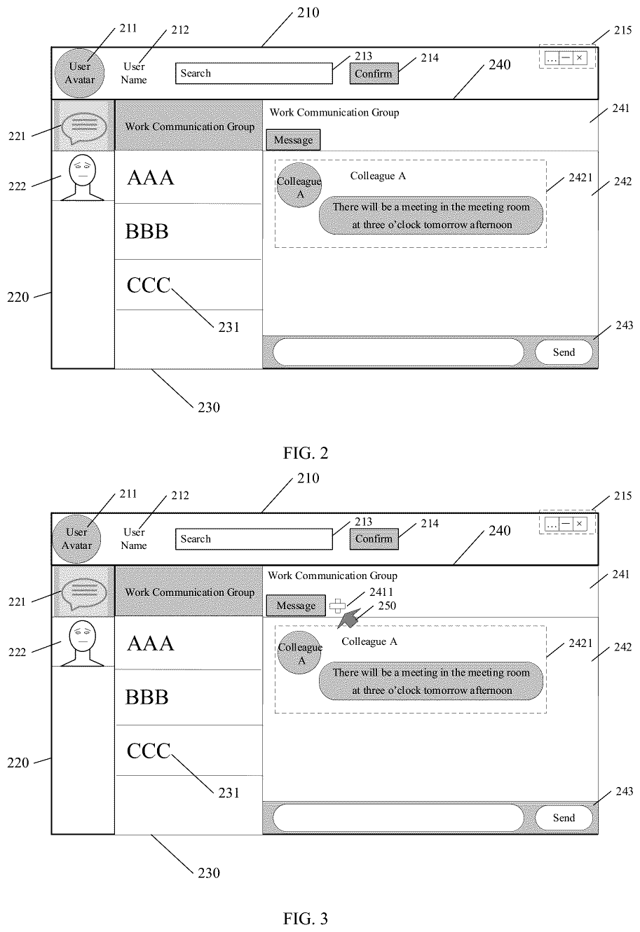

Refer to what is shown in FIG. 2, which is a schematic diagram of a display interface of a client side provided in an embodiment of the present application. In the display area of the client side, are included a basic information display area 210, a control display area 220, a session list display area 230, and a session interface 240.

The basic information display area 210 can include a user avatar display area 211, a user name display area 212, a content search box 213, a search control 214 and an operation control set 215. The user avatar display area 211 is used to display the avatar set by a user currently logging in to the client side; the user name display area 212 is used to display the user name or nickname for a user currently logging in to the client side; the content search box 213 is used to receive keywords or other contents input by a user; the search control 214 is used to trigger a search operation on the client side; the operation control set 215 can include at least one operation control, and a user can trigger operations such as the operation of closing the client side, the operation of minimizing the client side and the like, by triggering the operation control(s) in the operation control set.

The control display area 220 displays at least one operation control, and includes a message viewing control 221 and an address book viewing control 222. The message viewing control 221 is used to cause the client side to display message notifications in the session list display area 230 after being triggered, such as group chat message notifications or private chat message notifications. As shown in FIG. 2, the message viewing control 221 is in a triggered state. The address book viewing control 222 is used to cause the client side to display an address book after being triggered. In FIG. 2, the address book viewing control 222 is in an untriggered state.

The session list display area 230 includes a piece or pieces of session information 231, which include(s) group chat session information and private chat session information; private chat session information is identified by nicknames for other users edited by the first user, and group chat session information is identified by group chat names. As shown in FIG. 2, the group chat session identified as “Work Communication Group” is in a triggered state.

The session interface 240 includes a title bar 241, a message display area 242 and an input area 243. Referring to what is shown in FIG. 2, the session interface 240 is a group chat interface for displaying group chat messages. Correspondingly, the title bar 241 can be used to display a group chat name corresponding to group chat messages; the message display area 242 can be used to display at least one group chat message 2421, and can also be used to display relevant information about the sender of the group chat message; and the input area 243 is used to receive and send group chat messages that the first user wants to send.

The display interface and the session interface of the client side are specifically introduced above by taking FIG. 2 as an example. It can be seen from FIG. 2 that in the session interface, the first user and the second user (other users in a group chat) can have a conversation, and can also access a first object which is a cloud file or a local file. The cloud file is a file stored in a cloud side, and can be sent and shared by sharing information about its storage address. The cloud file can include cloud documents, cloud tables, cloud images or cloud videos. The local file is a file stored locally, and can include local documents, local tables, local images or local videos.

Referring to what is shown in FIG. 3, on the basis of the session interface 240 shown in FIG. 2, the title bar 241 also includes an object addition control 2411 located at a top of the message display area 242 in the session interface 240. The client side receives the object adding operation triggered by the first user in the session interface 240, which can be a click operation of the object addition control 2411 in the session interface 240, triggered by the first user, and specifically, can be the object adding operation triggered by the first user using a mouse control 250 to click on the area where the object addition control 2411 is located.

S102: Adding a first object in the session interface according to the object adding operation.

In the embodiments of the present application, in response to the first user using the mouse control 250 to click on the area where the object addition control 2411 is located, the client side adds the first object in the session interface 240 according to the object adding operation triggered by the first user.

Two implementation modes of adding the first object in the session interface are introduced below by taking cloud documents as an example.

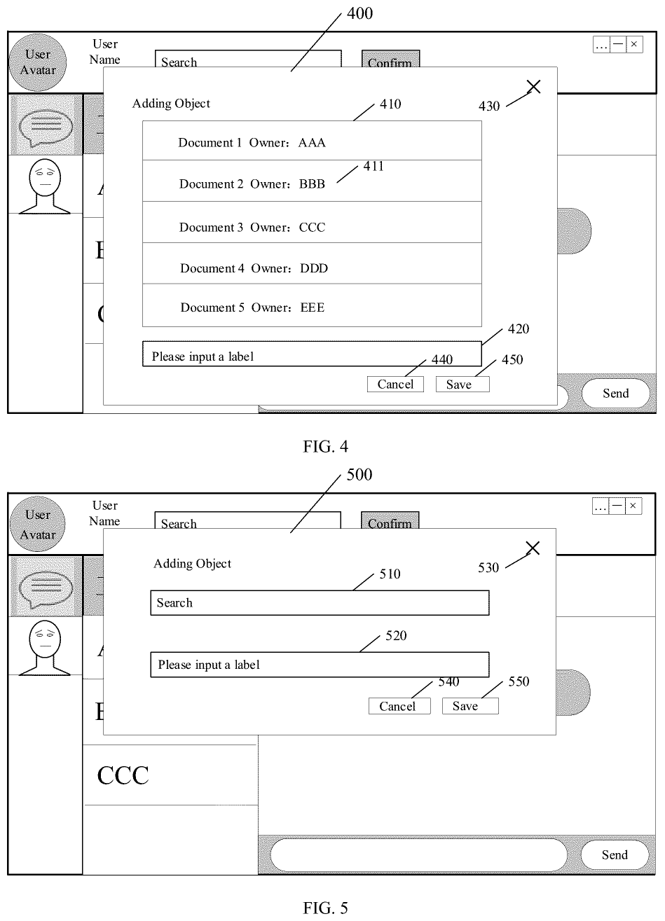

A first implementation mode: After a response to the first user using the mouse control 250 to click on the area where the object addition control 2411 is located, and namely, after the first user triggers the object adding operation in the session interface 240, referring to what is shown in FIG. 4, the display interface of the client side shown in FIG. 4 is based on that of the client side in FIG. 3. The client side can display an object addition interface 400, which includes a candidate object selection area 410, a label editing box 420, a close control 430, a cancellation control 440 and a save control 450.

The candidate object selection area 410 displays at least one candidate object 411 and related information about the candidate object 411, such as a name for the candidate object, a link to the candidate object, or a name for an owner of the candidate object. In FIG. 4, the candidate object 411 shown in the candidate object selection area 410 is a cloud document whose name is also shown. The at least one candidate object 411 displayed in the candidate object selection area 410 includes the first object. After a response to the first user using the mouse control 250 to click on the area where the first object is located, and namely, after the client side receives the first user's selection operation to the first object, the first object can be added in the session interface.

The label editing box 420 is used to receive a keyword input by the first user, which is a label of the first object. The label of the first object can subsequently be displayed in the session interface to facilitate the first user finding the first object. If the client side does not receive the keyword input by the first user, the title of the first object is the label of the first object by default.

The close control 430 is used to close the object addition interface 400. The cancellation control 440 is used to cancel the first user's previous operation. The save control 450 is used to save operations performed by the first user in the object addition interface 400.

Referring to what is shown in FIG. 4, after the first user triggers the object adding operation in the session interface, the display interface of the client side displays the object addition interface 400. The object addition interface displays at least one candidate object, from which the first object is selected, and subsequently, the first object will be added to the display interface of the client side.

A second implementation mode: After a response to the first user using the mouse control 250 to click on the area where the object addition control 2411 is located, and namely, after the first user triggers the object adding operation in the session interface 240, referring to what is shown in FIG. 5, the display interface of the client side shown in FIG. 5 is based on that of the client side in FIG. 3. The client side can display the object addition interface 500 which includes an object search box 510, a label editing box 520, a close control 530, a cancellation control 540 and a save control 550.

The object search box 510 is used to receive a keyword for the first object input by the first user. The keyword is information about the first object, including one or more of followings: a name for the first object, a link to the first object, and a name for an owner of the first object.

The label editing box 520 is used to receive a keyword input by the first user, which is a label of the first object. The label of the first object can subsequently be displayed in the session interface to facilitate the first user triggering the opening of the first object. If the client side does not receive a keyword input by the first user, the title of the first object is the label of the first object by default. The label of the first object can be the title of a cloud file or the title of a local file.

The close control 530 is used to close the object addition interface 500. The cancellation control 540 is used to cancel the first user's previous operation. The save control 550 is used to save an operation performed by the first user in the object addition interface 500.

Referring to what is shown in FIG. 5, after the first user triggers the object adding operation in the session interface, the display interface of the client side displays the object addition interface 500; and after the information about the first object input by the first user is obtained through the object search box 510 in the object addition interface 500, the client side obtains the first object according to the information about the first object, and subsequently, the first object will be added to the display interface of the client side.

It should be noted that, without contradiction, the two implementation modes of adding the first object in the session interface can be combined. Moreover, the solution obtained by the combination is also covered by the protection scope of the embodiments of the present application.

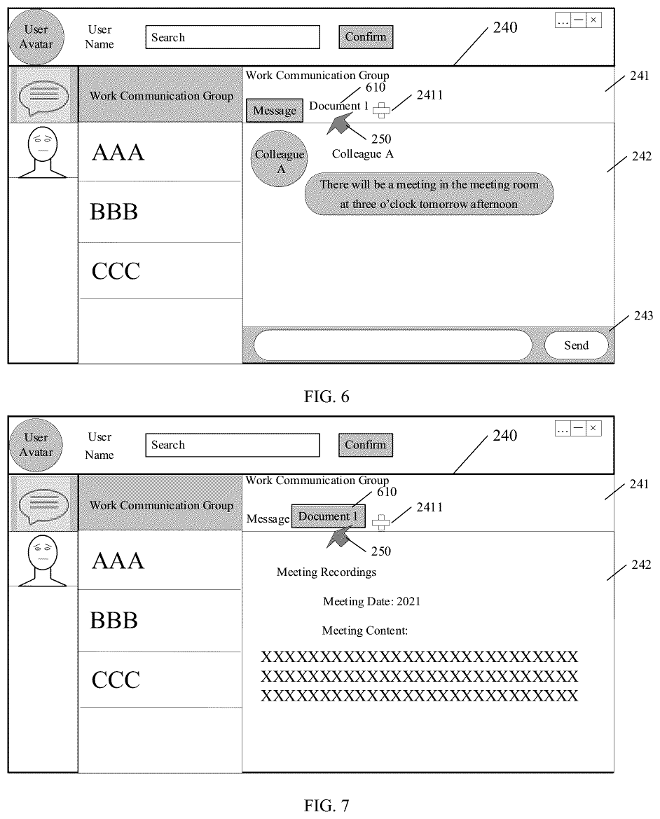

The specific process of adding the first object in the session interface according to the object adding operation, is introduced above. After the addition of the first object is completed, the label of the first object will be displayed in the display interface of the client side. Referring to what is shown in FIG. 6, the display interface of the client side shown in FIG. 6 is based on that of the client side in FIG. 3. In the title bar 241 of the session interface 240 is displayed a label 610 of the first object, which is located at a top of the message display area 242 in the session interface 240. In the title bar 241 shown in FIG. 6, the label 610 of the first object is displayed by taking cloud documents as an example, and herein is specifically “Document 1”.

In the embodiments of the present application, the first object can be opened by triggering the label of the first object; and namely, in response to the first user using the mouse control 250 to click on the area in the title bar 241 where the label 610 of the first object is located, referring to what is shown in FIG. 7, the display interface of the client side shown in FIG. 7 is based on that of the client side in FIG. 6. In the display interface of the client side, the label 610 of the first object is in a triggered state, displaying specific contents of the first object. In FIG. 7, specific contents of the cloud document are displayed by taking a cloud document as an example, and the cloud document relates specifically to contents of meeting records.

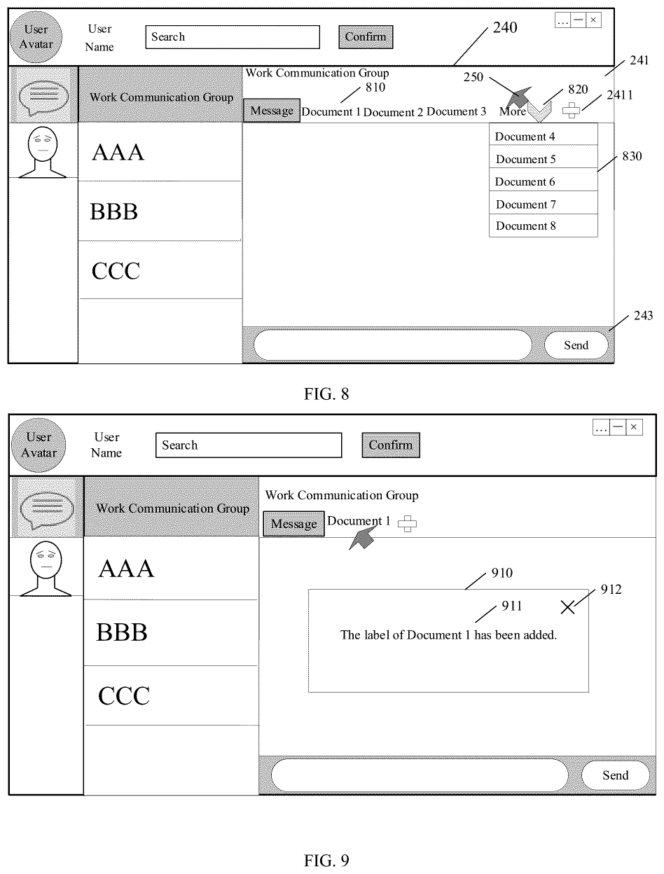

Referring to what is shown in FIG. 8, the display interface of the client side shown in FIG. 8 is based on that of the client side in FIG. 6. In the display interface of the client side can be simultaneously displayed labels 810 of multiple objects including the first object. The labels 810 of the plurality of objects are respectively displayed in the title bar 241 of the session interface 240, and are located at a top of the message display area 242 in the session interface 240. In order to display as many objects as possible at a top of the message display area 242, the number of displayed characters of each object's label can be limited, and for example, it is less than 6.

Continuing to refer to what is shown in FIG. 8, the title bar 241 also includes a MORE display control 820. When many objects have been added in the session interface 240, all the objects cannot be displayed in the title bar 241. After a response to the first user using the mouse control 250 to click on the area where the MORE display control 820 is located or a response to the first user's mouse control 250 being located in the area where the MORE display control 820 is located, a MORE display interface 830 is used in the session interface 240 to display the remaining objects except the objects displayed in the title bar 241.

In the embodiments of the present application, after the first user adds the first object in the session interface, the second user can also access the first object. Similarly, after the second user adds a second object in the session interface, the first user can also access the second object in the session interface. The client side can receive the first user's access operation of the label of the second object in the session interface, and then display the second object according to the access operation.

In the embodiments of the present application, after the first user adds the first object in the session interface, the client side can generate a notification message and send it to the session interface. The notification message is used to remind the first user and/or the second user that the first object has been added in the session interface. Referring to what is shown in FIG. 9, the display interface of the client side shown in FIG. 9 is based on that of the client side in FIG. 6. The display interface of the client side in FIG. 9 includes a notification message display area 910 including a notification message content area 911 and a close control 912. The notification message content area 911 is used to display the content of the first object having been added in the session interface, and the close control 912 is used to close the notification message display area 910.

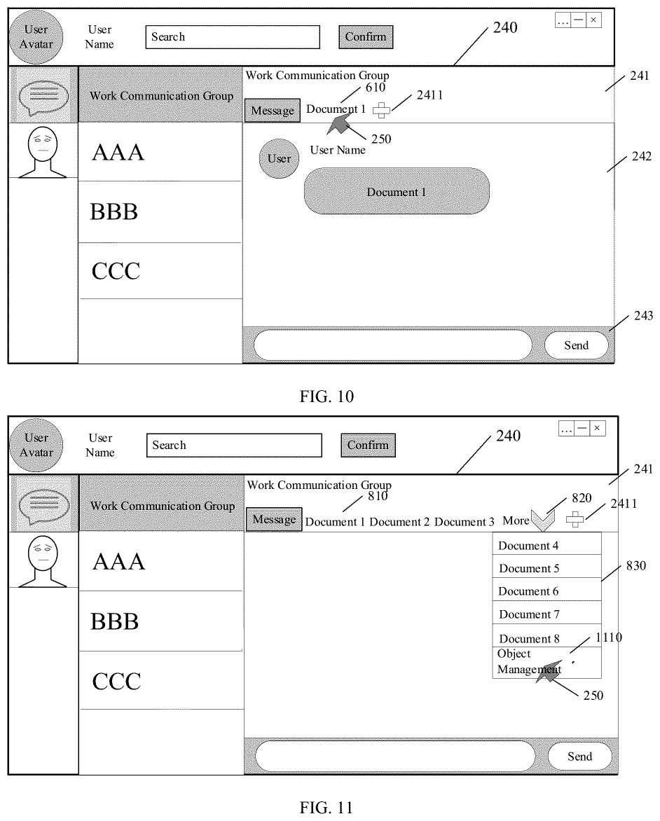

In the embodiments of the present application, after the first user triggers the object adding operation in the session interface and the first object is displayed in the title bar of the session interface, the first object can also be sent to the second user through the session interface. Referring to what is shown in FIG. 10, the display interface of the client side shown in FIG. 10 is based on that of the client side in FIG. 6. The first user can send the first object 261 in the form of message through an input area 243, in the session interface 240.

That is to say, in the embodiments of the present application, no matter whether the first user sends the first object in the session interface, as long as the first user adds the first object in the session interface, the second user can access the first object according to the label of the first object.

In the embodiments of the present application, after multiple objects are added in the session interface, the plurality of objects that have been added can also be managed, including deleting an object and sequencing the plurality of objects.

Referring to what is shown in FIG. 11, the display interface of the client side shown in FIG. 11 is based on that of the client side in FIG. 8. In the title bar 241 of the session interface 240 shown in FIG. 11 is included the MORE display control 820. After a response to the first user using the mouse control 250 to click on the area where the MORE display control 820 is located or a response to the first user's mouse control 250 being located in the area where the MORE display control 820 is located, in the session interface 240 is displayed the MORE display interface 830 which includes an object management control 1110 used to manage one or more added objects.

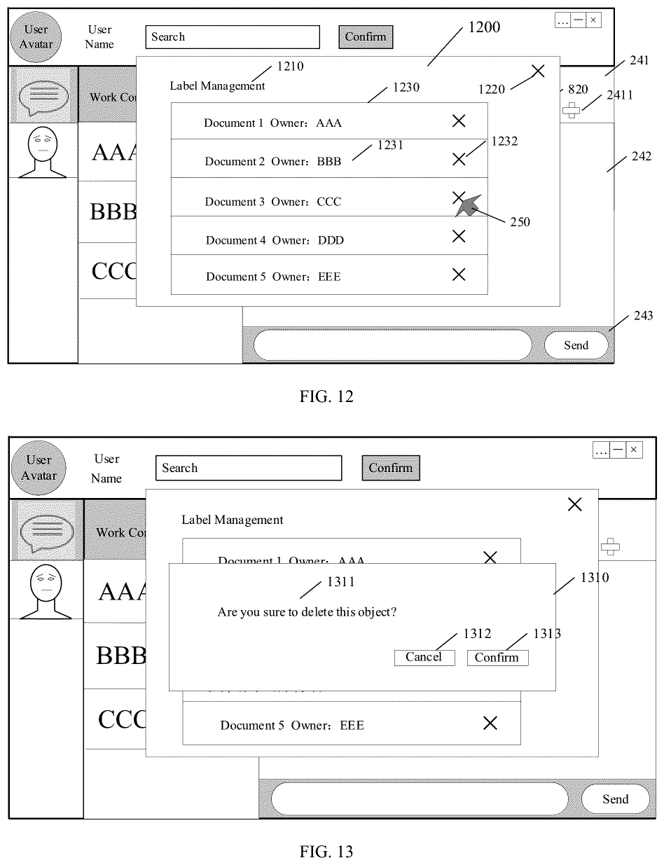

The client side receives a management interface display operation triggered by the first user, and namely, the client side responds to the first user using the mouse control 250 to click on the area where the object management control 1110 is located; and referring to what is shown in FIG. 12, the display interface of the client side shown in FIG. 12 is based on that of the client side in FIG. 11. After the first user clicks on the object management control 1110, the management interface display operation is triggered, and then the client side displays the object management interface 1200 in the session interface 240 according to the management interface display operation.

The object management interface 1200 includes an interface name area 1210, a close control 1220, and an added-object area 1230. The interface name area 1210 is used to display a name for the interface currently displayed on the client side, such as “Label Management” shown in FIG. 12, and is reflected as an object management interface for multiple objects. The close control 1220 is used to exit the object management interface 1200. The added-object area 1230 displays a plurality of objects that have been added 1231.

When the first object has not been added in the session interface, the first object is excluded from the plurality of objects displayed in the object management interface 1200 that have been added.

When the first object has been added in the session interface, the first object is included in the plurality of objects displayed in the object management interface 1200 that have been added.

In actual applications, after the first object is added in the session interface, the first object can also be deleted. Two implementation modes of deleting the first object are introduced below.

A specific application scenario of a first implementation mode is that after the first user sends the first object to the second user through the session interface, the first object can be withdrawn, and namely, the client side can receive the first user's withdrawal operation against the first object that has been sent, and delete the label of the first object added in the session interface according to a withdrawal operation.

A second implementation mode is to directly delete the first object added in the session interface, and namely, the client side can receive the first user's deletion operation of the first object, and delete the label of the first object added in the session interface according to the deletion operation.

Continuing to refer to FIG. 12, in the session interface 240 is displayed the object management interface 1200 which displays a plurality of objects 1231 that have been added and include the first object. The object management interface 1200 also includes deletion controls 1232. Each object corresponds to a deletion control 1232 used to delete the object. After a response to the first user using the mouse control 250 to click on the area where the deletion control 1232 corresponding to the first object is located, and namely, after the client side receives the first user's triggering operation to the deletion control 1232 of the first object, the first object is deleted according to the triggering operation.

In actual applications, in order to prevent accidental deletion of the first object resulting from a user accidentally clicking on the deletion control, a deletion confirmation interface can also be displayed in the display interface after the client side receives the user's clicking on the deletion control. Referring to what is shown in FIG. 13, the display interface of the client side shown in FIG. 13 is based on that of the client side in FIG. 12. In response to the first user using the mouse control 250 to click on the area where the deletion control 1232 corresponding to the first object is located, the display interface of the client side displays a deletion confirmation interface 1310 including a deletion content display area 1311, a cancellation control 1312 and a deletion confirmation control 1313. The deletion content display area 1311 is used to remind the first user whether to confirm the deletion of the object, the cancellation control 1312 is used to cancel the deletion of the first object, and the deletion confirmation control 1313 is used to confirm the deletion of the first object.

It should be noted that, without contradiction, the two implementation modes of deleting the first object in the session interface can be combined. Moreover, the solution obtained by the combination is also covered by the protection scope of the embodiments of the present application.

In the embodiments of the present application, after the first user deletes the first object from the session interface, the client side can generate a notification message and send it to the session interface. The notification message is used to notify the first user and/or the second user that the first object has been deleted.

In actual applications, after adding multiple objects to the session interface, the plurality of objects can also be sequenced. The client side receives a sequencing operation of the plurality of objects triggered by the first user, and then sequences the plurality of objects according to the sequencing operation.

Continuing to refer to the display interface of the client side shown in FIG. 12, in the session interface 240 is displayed the object management interface 1200 which displays a plurality of objects that have been added and include a third object. The client side receives the first user's adjustment operation of the display order of the third object in the object management interface, and then adjusts the display order of the plurality of objects in the object management interface according to the adjustment operation. That is to say, the client side responds to the first user's dragging operation of the third object in the session interface 240 by using the mouse control 250, to adjust the display order of the third object in the object management interface.

In the embodiments of the present application, the plurality of objects added in the session interface include the third object. The deletion of the third object by the second user does not affect the first user's access to the third object; that is to say, the first user can still access the third object. When the client side responds to the deletion of the third object by the second user and receives the first user's access operation of the third object, the third object is still displayed according to the access operation.

In the embodiments of the present application, when the first user adds the first object in the session interface, the access permission for the first object can also be added simultaneously. The access permission is a permission for the second user to access the first object, and for example, the second user can read and/or edit the first object.

After the first user adds the first object in the session interface, the access permission for the first object can also be modified. The client side can receive the first user's modification operation to the access permission for the first object, and then determine the access permission for the first object according to the modification operation.

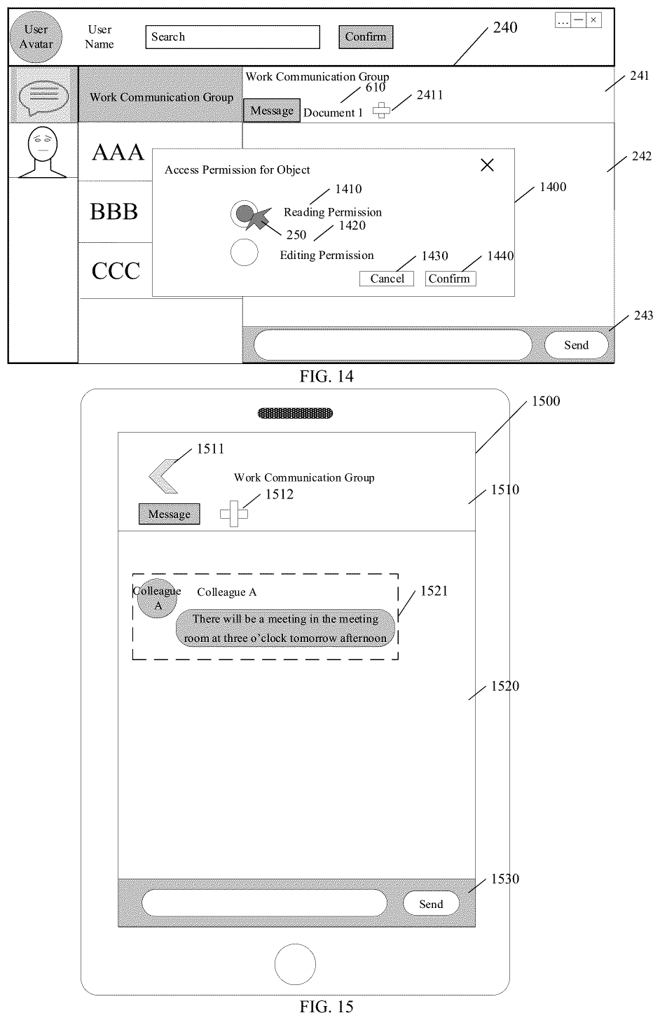

Referring to what is shown in FIG. 14, the display interface of the client side shown in FIG. 14 is based on that of the client side in FIG. 6. The session interface 240 shown in FIG. 14 includes an access permission editing interface 1400 including an object reading permission control 1410, an object editing permission control 1420, a cancellation control 1430 and a confirmation control 1440. Both the object reading permission control 1410 and the object editing permission control 1420 include their respective corresponding selected areas. There is a response to the first user using the mouse control 250 to click on the selected area corresponding to both the object reading permission control 1410 and the object editing permission control 1420 in the access permission editing interface 1400, to determine the first user's modification operation to the access permission for the first object.

The interaction method provided in the above embodiment is introduced by using a software client side installed on a personal computer, and that provided below is introduced by using a software client side installed on a mobile phone. Regardless of whether it is a software client side installed on a personal computer or a mobile phone, the interaction method embodiments provided have the same the steps, and the only difference lies in the display interface of the client side.

Refer to what is shown in FIG. 15, which is a schematic diagram of a display interface of a client side provided in an embodiment of the present application. In the display area of the client side is included a session interface 1500.

The session interface 1500 includes a title bar 1510, a message display area 1520, and an input area 1530. Referring to what is shown in FIG. 15, the session interface 1500 is a group chat interface for displaying group chat messages. Correspondingly, the title bar 1510 can be used to display a group chat name corresponding to group chat messages. The title bar 1510 includes a return control 1511 used to exit the session interface 1500; the message display area 1520 can be used to display at least one group chat message 1521, and can also be used to display relevant information about the sender of the group chat message; and the input area 1530 is used to receive and send group chat messages the first user wants to send.

The title bar 1510 also includes an object addition control 1512 located at a top of the message display area 1520 in the session interface 1500. The client side receives an object adding operation triggered by the first user in the session interface 1500, which can be a click operation of the object addition control 1512 in the session interface 1500, triggered by the first user, and specifically, can be an object adding operation triggered by the first user touching and clicking on the area where the object addition control 1512 is located.

In response to the first user touching and clicking on the area where the object addition control 1512 is located, the client side adds the first object in the session interface 1500 according to the object adding operation triggered by the first user.

Two implementation modes of adding the first object in the session interface are introduced below by taking cloud documents as an example.

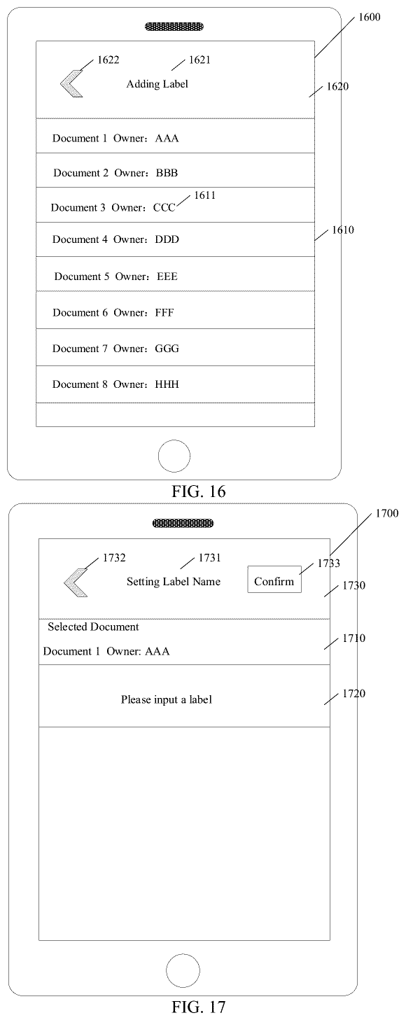

A first implementation mode: After a response to the first user touching and clicking on the area where the object addition control 1512 is located, and namely, after the first user triggers the object adding operation in the session interface 1500, referring to what is shown in FIG. 16, the display interface of the client side shown in FIG. 16 is obtained from a jump of the display interface of the client side in FIG. 15. The client side can display an object addition interface 1600 including a candidate object selection area 1610 and a title display area 1620.

The title display area 1620 includes an interface name area 1621 and a return control 1622. The interface name area 1621 is used to display a name for the interface currently displayed on the client side, such as “Adding Label” shown in FIG. 16, and is reflected as an interface for adding the first object. The return control 1620 is used to exit the object addition interface 1600.

The candidate object selection area 1610 displays at least one candidate object 1611 and related information about the candidate object 1611, such as a name for the candidate object, a link to the candidate object, or a name for an owner of the candidate object. The candidate object 1611 shown in the candidate object selection area 1610 in FIG. 16 is a cloud document, and a name for the cloud document is also shown. The at least one candidate object 1611 displayed in the candidate object selection area 1610 includes the first object. In response to the first user touching and clicking on the area where the first object is located, and namely, in response to the client side receiving the first user's selection operation to the first object, referring to what is shown in FIG. 17, the display interface of the client side jumps to a label editing page 1700 for the first object.

The label editing page 1700 includes a selected-object area 1710, a label editing box 1720, and a title display area 1730.

The title display area 1730 includes an interface name area 1731, a return control 1732, and a save control 1733. The interface name area 1731 is used to display a name for the interface currently displayed on the client side, for example, “Setting Label Name” shown in FIG. 17, and is reflected as an editing interface for the label of the first object. The return control 1732 is used to exit the label editing page 1700. The save control 1733 is used to save operations performed by the first user on the label editing page 1700.

The selected-object area 1710 is used to display the first object selected by the first user from multiple candidate objects and information about the first object, such as a name for the first object, a link to the first object, or a name for an owner of the first object.

The label editing box 1720 is used to receive a keyword input by the first user, which is a label of the first object. The label of the first object can subsequently be displayed in the session interface to facilitate the first user finding the first object. If the client side does not receive the keyword input by the first user, the title of the first object is the label of the first object by default.

In response to the first user touching and clicking on the save control 1733, the first object will be subsequently added to the display interface of the client side.

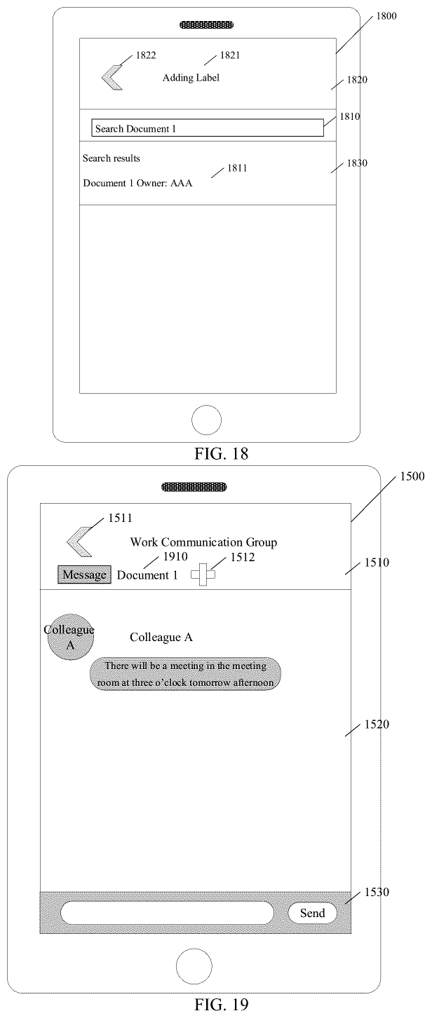

A second implementation mode: After a response to the first user touching and clicking on the area where the object addition control 1512 is located, and namely, after the first user triggers the object adding operation in the session interface 1500, referring to what is shown in FIG. 18, the display interface of the client side shown in FIG. 18 is obtained from a jump of the display interface of the client side in FIG. 15. The client side can display an object addition interface 1800 including an object search box 1810, a title display area 1820, and a searched-object display area 1830.

The title display area 1820 includes an interface name area 1821 and a return control 1822. The interface name area 1821 is used to display a name for the interface currently displayed on the client side, such as “Adding Label” shown in FIG. 18, and is reflected as an interface for adding the first object. The return control 1820 is used to exit the object addition interface 1800.

The object search box 1810 is used to receive a keyword for the first object input by the first user. The keyword is information about the first object, including one or more of followings: a name for the first object, a link to the first object, and a name for an owner of the first object.

The searched-object display area 1830 is used to display objects searched according to the information about the first object.

Referring to what is shown in FIG. 18, after the first user triggers the object adding operation in the session interface, the display interface of the client side displays the object addition interface 1800; and after the information about the first object input by the first user input is obtained through the object search box 1810 in the object addition interface 1800, the client side obtains the first object 1811 according to the information about the first object, and displays the first object 1811 in the object addition interface 1800.

In response to the first user touching and clicking on the area where the first object 1811 is located, and namely, in response to the client side receiving the first user's selection operation to the first object, the display interface of the client side jumps to the label editing page 1700 for the first object, and the label editing operation of the first object is continued.

It should be noted that, without contradiction, the two implementation modes of adding the first object in the session interface can be combined. Moreover, the solution obtained by the combination is also covered by the protection scope of the embodiments of the present application.

The specific process of adding the first object in the session interface according to the object adding operation, is introduced above. After the addition of the first object is completed, the label of the first object will be displayed in the display interface of the client side. Referring to what is shown in FIG. 19, the display interface of the client side shown in FIG. 19 is based on that of the client side in FIG. 15. In the title bar 1510 of the session interface 1500 is displayed a label 1910 of the first object, which is located at a top of the message display area 1520 in the session interface 1500. In the title bar 1510 shown in FIG. 19, the label 1910 of the first object is displayed by taking a cloud document as an example, and herein is specifically “Document 1”.

In the embodiments of the present application, the first object can be opened by triggering the label of the first object, and namely, in response to the first user touching and clicking on the area in the title bar 1510 where the label 1910 of the first object is located or touching and sliding left and right, referring to what is shown in FIG. 20, the display interface of the client side shown in FIG. 20 is obtained from a jump of the display interface of the client side in FIG. 19. In the display interface of the client side, the label 1910 of the first object is in a triggered state, displaying specific contents of the first object. In FIG. 20, specific contents of the cloud document are displayed by taking a cloud document as an example, and the cloud document relates specifically to contents of meeting records.

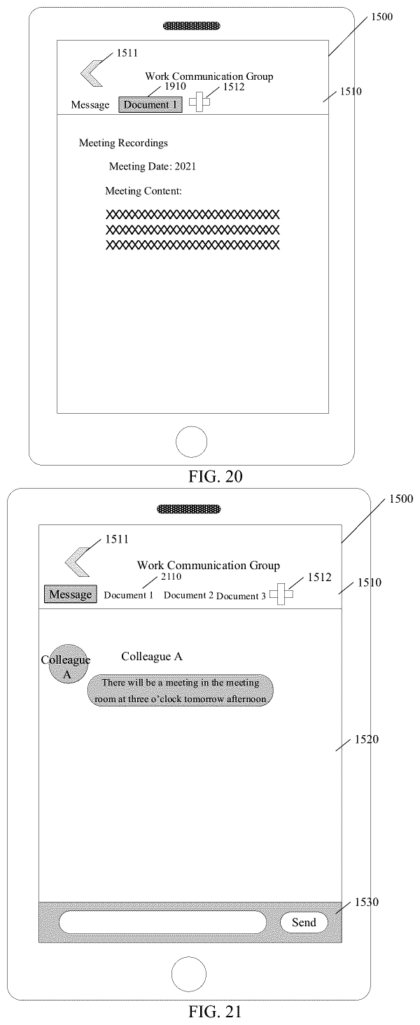

Referring to what is shown in FIG. 21, the display interface of the client side shown in FIG. 21 is based on that of the client side in FIG. 15. In the display interface of the client side can be simultaneously displayed labels 2110 of multiple objects including the first object. The labels 2110 of the plurality of objects are respectively displayed in the title bar 1510 of the session interface 1500, and are located at a top of the message display area 1520 in the session interface 1500. In order to display as many objects as possible in the title bar 1510, the number of displayed characters of each object's label can be limited, for example, it is less than 6.

Continuing to refer to what is shown in FIG. 21, the first user can switch from one to another of multiple objects and their respective display contents by touching and sliding left and right.

In the embodiments of the present application, after multiple objects are added in the session interface, the plurality of objects that have been added can also be managed, including deleting an object and sequencing multiple objects.

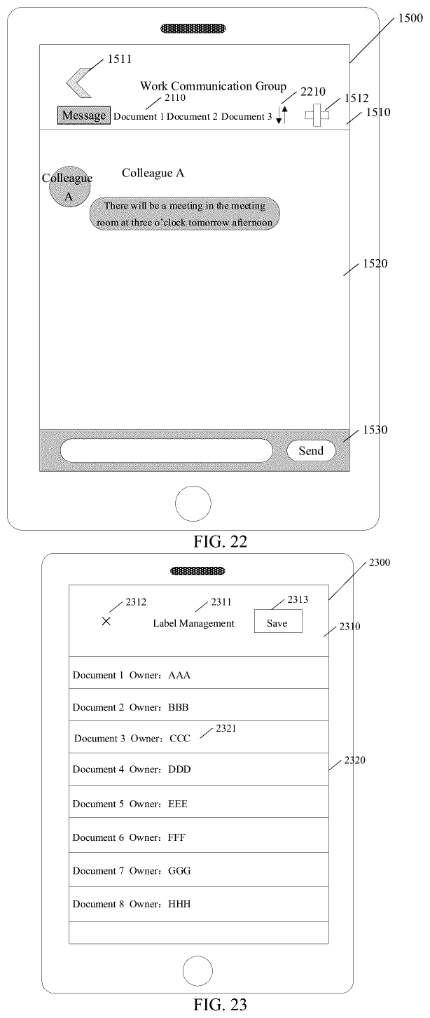

Referring to what is shown in FIG. 22, the display interface of the client side shown in FIG. 22 is based on that of the client side in FIG. 21. In the title bar 1510 of the session interface 1500 shown in FIG. 22 is included an object management control 2210 which is used to manage one or more added objects.

In response to the first user touching and clicking on the area where the object management control 2210 is located, referring to what is shown in FIG. 23, the display interface of the client side shown in FIG. 23 is obtained from a jump of the display interface of the client side in FIG. 22. After the first user clicks on the object management control 2210, a management interface display operation is triggered, and then the client side displays an object management interface 2300 according to the management interface display operation. The object management interface 2300 includes a title display area 2310 and an added-object area 2320.

The title display area 2310 includes an interface name area 2311, an exit control 2312 and a save control 2313. The interface name area 2311 is used to display a name for the interface currently displayed on the client side, such as “Label Management” shown in FIG. 23, and is reflected as an object management interface for multiple objects. The exit control 2312 is used to exit the object management interface 2300. The save control 2313 is used to save operations performed by the first user in the object management interface 2300.

In the added-object area 2320 are displayed the plurality of objects 2321 that have been added.

The client side responds to the first user's dragging operation of one or more objects 2321 in the object management interface 2310, to adjust the display order of the plurality of objects in the object management interface.

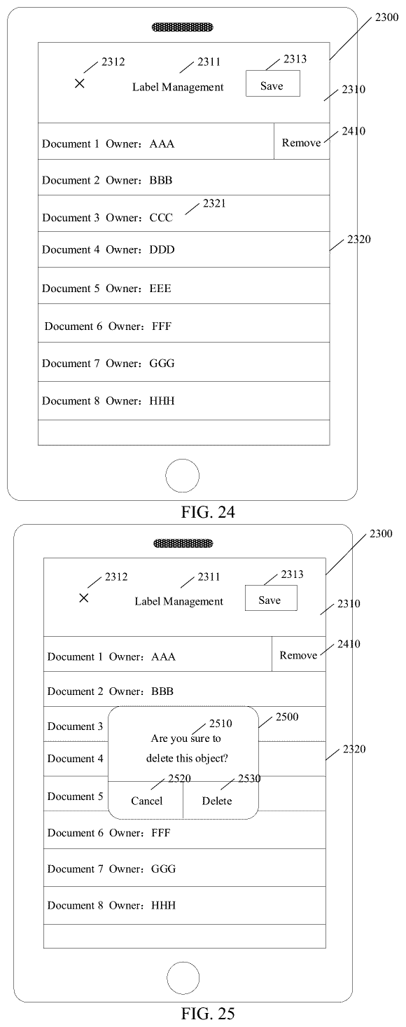

The client side responds to the first user's left sliding operation of an object 2321 in the object management interface 2310; and referring to what is shown in FIG. 24, the display interface of the client side shown in FIG. 24 is based on that of the client side in FIG. 23, and in the object management interface 2310 is displayed a removal control 2410 which is located in the area where the object 2321 selected by the first user's left sliding operation is located.

After a response to the first user touching and clicking on the area where the removal control 2410 is located, and namely, after the client side receives the first user's triggering operation to an object's removal control 2410, the label of the object is deleted according to the triggering operation.

In actual applications, in order to prevent accidental deletion of an object resulting from a user accidentally clicking on the deletion control, a deletion confirmation interface can also be displayed in the display interface after the client side receives the user's clicking on the removal control. Referring to what is shown in FIG. 25, the display interface of the client side shown in FIG. 25 is based on that of the client side in FIG. 24. In response to the first user touching and clicking on the area where the removal control 2410 corresponding to an object is located, in the display interface of the client side is displayed a deletion confirmation interface 2500 which includes a deletion content display area 2510, a cancellation control 2520 and a deletion confirmation control 2530. The deletion content display area 2510 is used to remind the first user whether to confirm the deletion of the object, the cancellation control 2520 is used to cancel the deletion of the object, and the deletion confirmation control 2530 is used to confirm the deletion of the object.

Based on this, the embodiment of the invention provides an interaction method, wherein a first user triggers an object adding operation aiming at a first object in a session interface for performing a conversation with one or more second users, then a client adds the first object in the session interface according to the object adding operation, the first object can be accessed by one or more second users, that is to say, after the first object is added in the session interface, the first user or the second user can directly and quickly access the first object on the session interface, the first object can be found without a chat record, and convenience is brought to the users.

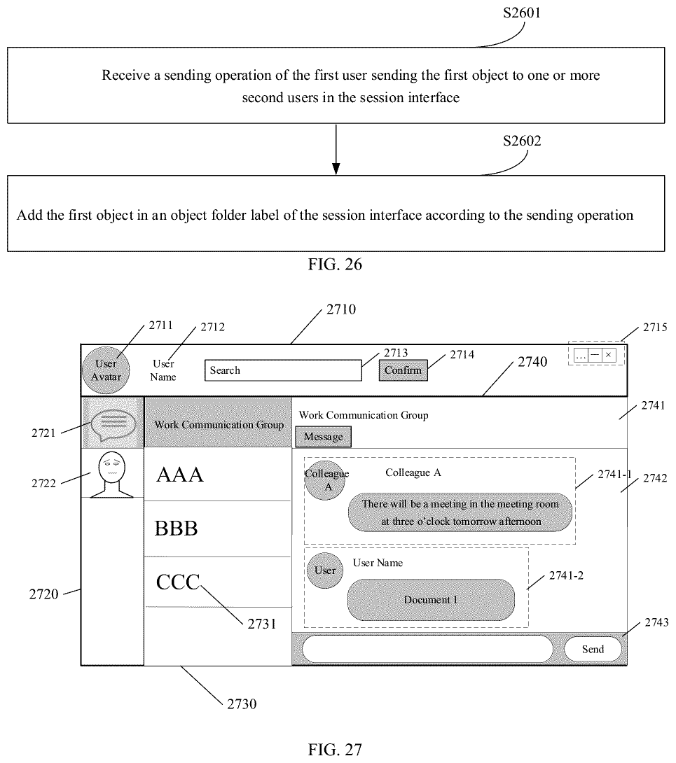

Refer to FIG. 26, which is a flow chart of another interaction method provided in an embodiment of the present application.

The interaction method provided in the embodiment of the present application is applied to a client side. Herein, the client side can be a terminal device, which is a hardware device that can communicate, such as a mobile phone, a tablet computer, or a personal computer (PC). The client side can also be a software client side used for communication. The interaction method provided in the following embodiment is introduced by using a software client side installed on a personal computer.

The interaction method provided in the embodiment includes the following steps.

S2601: Receiving a sending operation of a first user sending a first object to one or more second users in a session interface.

In embodiments of the present application, the first user is a user who communicates in the session interface of the client side. The session interface is an interface where the first user has a conversation with one or more second users through the client side. The conversation can be a voice conversation or a text conversation. In the session interface can be included merely the first user and one second user who have a separate one-to-one communication, and namely the session interface is a private chat message interface. In the session interface can also be included the first user and multiple second users, and namely the session interface can be a group chat message interface.

Refer to what is shown in FIG. 27, which is a schematic diagram of a display interface of a client side provided in an embodiment of the present application. In the display area of the client side are included a basic information display area 2710, a control display area 2720, a session list display area 2730, and a session interface 2740.

The basic information display area 2710 can include a user avatar display area 2711, a user name display area 2712, a content search box 2713, a search control 2714 and an operation control set 2715. The user avatar display area 2711 is used to display the avatar set by the user currently logging on to the client side; the user name display area 2712 is used to display the user name or nickname for the user currently logging on to the client side; the content search box 2713 is used to receive keywords or other contents input by the user; the search control 2714 is used to trigger a search operation on the client side; the operation control set 2715 can include at least one operation control, and the user can trigger operations such as the operation of closing the client side, the operation of minimizing the client side and the like, by triggering the operation control(s) in the operation control set.

At least one operation control is displayed in the control display area 2720 which includes a message viewing control 2721 and an address book viewing control 2722. The message viewing control 2721 is used to cause the client side to display message notifications in the session list display area 2730 after being triggered, such as group chat message notifications or private chat message notifications. As shown in FIG. 27, the message viewing control 2721 is in a triggered state. The address book viewing control 2722 is used to cause the client side to display an address book after being triggered. In FIG. 27, the address book viewing control 2722 is in an untriggered state.

The session list display area 2730 includes a piece or pieces of session information 2731. The session information 2731 includes group chat session information and private chat session information. The private chat session information is identified by nicknames for other users edited by the first user, and the group chat session information is identified by group chat names. As shown in FIG. 27, the group chat session identified as “Work Communication Group” is in a triggered state.

The session interface 2740 includes a title bar 2741, a message display area 2742, and an input area 2743. Referring to what is shown in FIG. 27, the session interface 2740 is a group chat interface for displaying group chat messages. Correspondingly, the title bar 2741 can be used to display a group chat name corresponding to group chat messages; the message display area 2742 can be used to display at least one group chat message 2741-1, and can also be used to display information about the sender of the group chat message; and the input area 2743 is used to receive and send the group chat message the first user wants to send.

The display interface and the session interface of the client side are specifically introduced above by taking FIG. 27 as an example. It can be seen from FIG. 27 that in the session interface, the first user and the second user (other users in the group chat) can have a conversation, and can also send a first object which is a cloud file or a local file. The cloud file is a file stored in a cloud side, and can be sent and shared by sharing information about its storage address. The cloud file can include cloud documents, cloud tables, cloud images or cloud videos. The local file is a file stored locally, and can include local documents, local tables, local images or local videos.

In response to the first user's sending operation of the first object in the session interface, the client side displays the first object in the session interface. Continuing to refer to what is shown in FIG. 27, in FIG. 27, the display interface of the client side that has completed the sending of the first object, is displayed by taking cloud documents as an example. After the first user sends the first object, the first object 2741-2 is displayed in the message display area 2742 in the form of group chat messages.

S2602: Adding the first object in an object folder label of the session interface according to the sending operation.

In the embodiments of the present application, the object folder label is a set of multiple objects. After the client side receives the sending operation of the first user sending the first object, the first object will be automatically added to the object folder label of the session interface.

In actual applications, if it is for the first time that the first object is sent by the first user and there is no object folder label of the first object in the session interface, when the first user sends the first object for the first time, the object folder label of the first object is added in the session interface according to the sending operation of the first object, and then the first object is added to the object folder label. If it is not for the first time that the first object is sent by the first user and there has existed the object folder label of the first object in the session interface, the first object is directly added to the existing object folder label.

In the embodiments of the present application, the object folder label can be located in the title bar of the session interface and at a top of the message display area in the session interface.

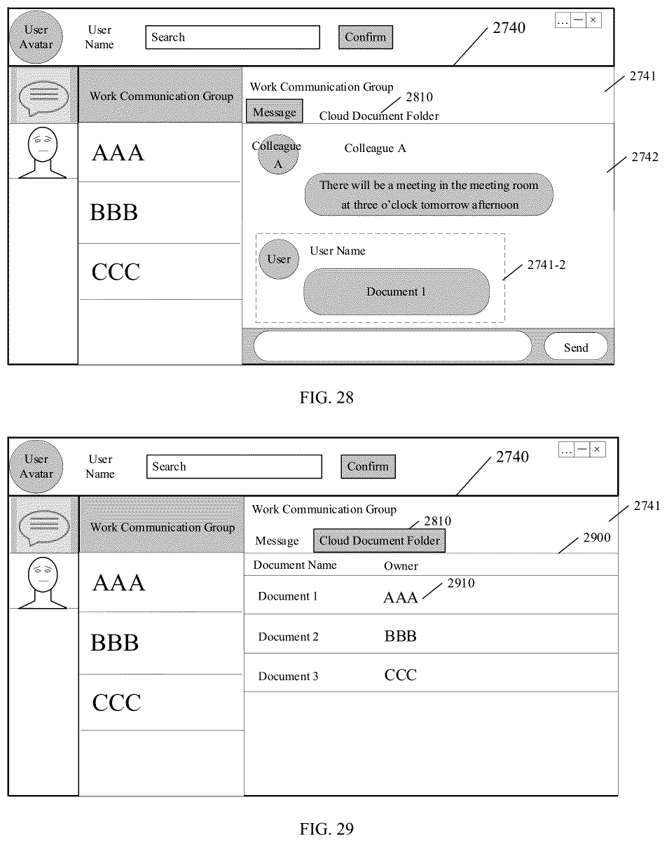

Referring to what is shown in FIG. 28, the display interface of the client side shown in FIG. 28 is based on that of the client side shown in FIG. 27. In response to the first user sending the first object 2741-2 for the first time and there being no the first object in the session interface, the object folder label 2810 of the first object is added to the title bar 2741 of the session interface, with the object folder label 2810 located at a top of the message display area 2742 in the session interface 2740. In the embodiments of the present application, object folder labels can be classified into multiple types according to the types of objects. For example, object folder labels can include cloud folders, local folders and the like. Cloud folders can include a cloud document folder, cloud image folders, and cloud video folders. The object folder label 2810 is shown in FIG. 28 by taking a cloud document folder as an example, and herein is specifically “cloud document folder”.

In the embodiments of the present application, the client side can receive a display operation triggered by the first user for the object folder label, and display an object interface according to the display operation, with the object interface including the first object that has been added. The display operation triggered by the first user for the object folder label can be the client side's response to the first user using the mouse control to click on the area in the title bar 2741 where the object folder label 2810 is located, and referring to what is shown in FIG. 29, the display interface of the client side shown in FIG. 29 is based on that of the client side in FIG. 28. In the display interface of the client side is displayed an object interface 2900, whose specific contents are displayed in FIG. 29 by taking a cloud document folder as an example.

The object interface 2900 includes a plurality of objects 2910 that have been added and information about the plurality of objects, with the plurality of objects 2910 including the first object. Information about each object includes a name for the object, a link to the object, the time the object was sent, and a name for an owner of the object.

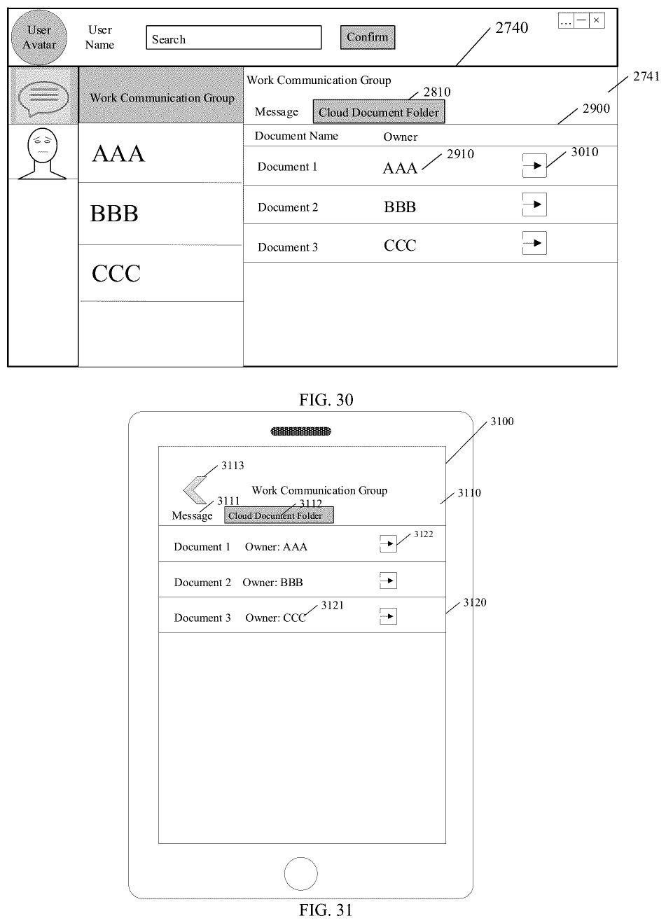

In the embodiments of the present application, referring to what is shown in FIG. 30, the display interface of the client side shown in FIG. 30 is based on that of the client side in FIG. 29. The object interface 2900 can also include jump controls 3010. Of multiple objects 2910 included in the object interface 2900, each object corresponds to a jump control 3010. The client side can receive the triggering operation to a jump control by the first user, and jump to a position of the first object in a conversation according to the triggering operation.

In response to the first user using the mouse control to click on the area where the jump control 3010 of the first object is located, continuing to refer to what is shown in FIG. 28, in the display interface of the client side shown in FIG. 28 is displayed the position of the first object in a conversation of the session interface.

The session interface in the interaction method provided in the embodiment of the present application can be a meeting group interface. When a member creates a schedule and chooses to create a meeting group, a meeting group assistant will pull the organizer and participants of the meeting into the meeting group, thus forming a meeting group interface. The meeting group interface usually sends many cloud files or meeting minutes, so the object folder can include cloud folders and the first object includes meeting minutes.

The session interface in the interaction method provided in the embodiment of the present application exclude one or more of secret chat interfaces and topic group interfaces. Information in a conversation in a secret chat group is confidential information and does not require the interaction methods in the embodiments of the present application. A topic group is a group where people with the same concerns in a team gather together to communicate various “topics” with each other. All contents in a topic group are displayed in aggregation according to “topics”. Members can actively post topics, and can also reply and subscribe to topics of interest. Replies to the same topic will be aggregated, and members can view all the contents by entering the details. A topic group does not require the interaction methods in the embodiments of the present application, either.

The interaction method provided in the above embodiment is introduced by using a software client side installed on a personal computer, and that provided below is introduced by using a software client side installed on a mobile phone. Regardless of whether it is a software client side installed on a personal computer or a mobile phone, the interaction method embodiments provided have the same the steps, and the only difference lies in the display interface of the client side.

Refer to what is shown in FIG. 31, which is a schematic diagram of a display interface of a client side provided in an embodiment of the present application. In the display area of the client side is included a session interface 3100.

The session interface 3100 includes a title bar 3110 and an object interface 3120. The title bar 3110 also includes a message control 3111, an object folder label 3112, and a return control 3113. The specific contents of the object interface is shown in FIG. 31 by taking a cloud document folder as an example.

The title bar 3110 can be used to display a group chat name corresponding to group chat messages. The message control 3111 is used to return the interface where the first user has a conversation with multiple second users, and the message control 3111 is in an untriggered state. The object folder label 3112 is in a triggered state and is used to display the plurality of objects 3121 included in the object interface 3120 that have been added. The return control 3113 is used to exit the session interface 3100.

Continuing to refer to what is shown in FIG. 31, the object interface 3120 can also include jump controls 3122, and of the plurality of objects included in the object interface 3120, each object 3121 corresponds to a jump control 3122. The client side can receive the triggering operation to a jump control by the first user, and jump to a position of the first object in a conversation according to the triggering operation.

In response to the first user touching and clicking on the area where the jump control 3122 of the first object is located, in the display interface of the client side is displayed the position of the first object in a conversation of the session interface.

Based on this, the embodiment of the invention provides an interaction method, wherein a first user sends a first object in a session interface where the first user has a conversation with one or more second users, and then a client side adds the first object to a object folder label of the session interface according to a sending operation of the first user sending the first object. That is to say, after the first object is added in the session interface, the first user or the second users can directly access the first object through the object folder label in the session interface quickly, the first object can be found without a chat record, and convenience is brought to the users.

It should be noted that, without contradiction, the two interaction method embodiments provided in the present application can be combined. Moreover, the solution obtained by the combination is also covered by the protection scope of the embodiments of the present application.

Based on an interaction method provided in the above embodiments, in an embodiment of the present application is also provided an interaction device whose working principle is described in detail below in combination with the accompanying drawings.

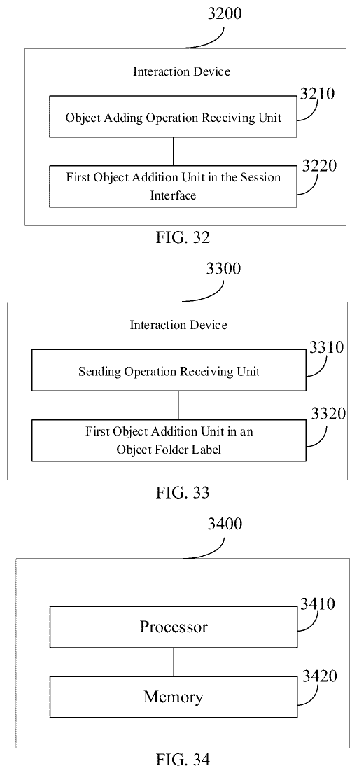

Refer to FIG. 32, which is a structural block diagram of an interaction device provided in an embodiment of the present application.

The interaction device 3200 provided in the embodiment includes:
an object adding operation receiving unit 3210, configured to receive an object adding operation triggered by a first user in a session interface, wherein the session interface is an interface where the first user has a conversation with one or more second users; and
a first object addition unit 3220 in the session interface, configured to add a first object in the session interface according to the object adding operation, wherein the first object is used to be accessed by the one or more second users.

Alternatively, the first object addition unit in the session interface is specifically used for:
adding a label of the first object in the session interface according to the object adding operation;
wherein the first object is opened when the label of the first object is triggered.

Alternatively, the first object addition unit in the session interface is specifically used for:
displaying at least one candidate object according to the object adding operation, wherein the at least one candidate object includes the first object; and
adding the first object in the session interface, in response to receiving a selection operation to the first object by the first user.

Alternatively, the first object addition unit in the session interface is specifically used for:
obtaining information about the first object input by the first user, according to the object adding operation; and
obtaining the first object according to the information about the first object, and adding the first object in the session interface, wherein the information about the first object includes one or more of followings:

a name for the first object, a link to the first object, and a name for an owner of the first object.

Alternatively, the device further includes:
a first access operation receiving unit, configured to receive an access operation by the first user of a label of a second object in the session interface, wherein the second object is an object which is added in the session interface by the second users; and a first display unit, configured to display the second object according to the access operation.

Alternatively, the device further includes:

a first sending unit, configured to send the first object to the one or more second users through the session interface.

Alternatively, the device further includes:
a withdrawal operation receiving unit, configured to receive a withdrawal operation by the first user against the first object that has been sent; and
a first deletion unit, configured to delete the first object added in the session interface according to the withdrawal operation.

Alternatively, the device further includes:
a deletion triggering operation receiving unit, configured to receive a triggering operation by the first user to a deletion control of the first object, wherein the deletion control is used for deleting the first object; and
a second deletion unit, configured to delete the first object according to the triggering operation.

Alternatively, the device further includes:
a second sending unit, configured to send a notification message in a session, wherein the notification message is used to notify that the first object has been deleted. Alternatively, the device further includes:

a first management interface display operation receiving unit, configured to receive a management interface display operation triggered by the first user; and
a second display unit, configured to display an object management interface according to the management interface display operation, wherein the object management interface includes a plurality of objects that have been added and exclude the first object; or,
the device further includes:

a second management interface display operation receiving unit, configured to receive a management interface display operation triggered by the first user; and
a third display unit, configured to display an object management interface according to the management interface display operation, wherein the object management interface includes a plurality of objects that have been added and include the first object.

Alternatively, the device further includes:
a sequencing operation receiving unit, configured to receive a sequencing operation of the plurality of objects triggered by the first user; and
a sequencing unit, configured to sequence the plurality of objects according to the sequencing operation.

Alternatively, the plurality of objects include a third object, and the device further includes:
a second access operation receiving unit, configured to, in response to the third object being deleted by the second user, to receive an access operation of the third object by the first user; and
a fourth display unit, configured to display the third object according to the access operation.

Alternatively, the device further includes:
a notification message generating unit, configured to generate a notification message and send it to the session interface, wherein the notification message is used to remind the first user and/or the second user that the first object has been added in the session interface. Alternatively, the device further includes:
an access permission modification operation receiving unit, configured to receive a modification operation by the first user to an access permission for the first object; and
a determining unit, configured to determine the access permission for the first object according to the modification operation, wherein the access permission is a permission for the second user to access the first object.

Refer to FIG. 33, which is a structural block diagram of another interaction device provided in an embodiment of the present application.

The interaction device 3300 provided in the embodiment includes:
a sending operation receiving unit 3310, configured to receive a sending operation of a first user sending a first object to one or more second users in a session interface, wherein the session interface is an interface where the first user has a conversation with one or more second users; and
a first object addition unit 3320 in an object folder label, configured to add the first object in the object folder label of the session interface according to the sending operation.

Alternatively, the first object addition unit in the object folder label is specifically used for:
adding an object folder label in the session interface according to the sending
operation; and
adding the first object to the object folder label.

Alternatively, the device further includes:
a display operation receiving unit, configured to receive a display operation of the object folder label triggered by the first user; and
an object interface display unit, configured to display an object interface according to the display operation, wherein the object interface includes the first object.

Alternatively, the object interface includes a jump control of the first object; The device further includes:
a jump control triggering operation receiving unit, configured to receive a triggering operation to the jump control by the first user; and
a jump unit, configured to jump to a position of the first object in the conversation according to the triggering operation.

Based on an interaction method provided in the above embodiments, in an embodiment of the present application is also provided an interaction device. Referring to what is shown in FIG. 34, the interaction device 3400 includes:
a processor 3410 and a memory 3420, wherein a number of the processor may be one or more. In some embodiments of the present application, the processor(s) and the memory can be connected through a bus or by other means.

The memory can include a read-only memory and a random access memory, and provides instructions and data for the processor. Part of the memory can also include a NVRAM. The memory stores operating systems and operating instructions, executable modules or data structures, or subsets thereof, or extended sets thereof, and the operating instructions can include various operating instructions, for implementing various operations. The operating systems can include various system programs, for implementing various basic services and processing hardware-based tasks.

The processor controls operations of a terminal device, and can also be called CPU.

The methods disclosed in the above embodiments of the present application can be applied to the processor or be implemented by the processor. The processor can be an integrated circuit chip with signal processing capabilities. In the implementation process, each step in the above methods can be completed by integrated logic circuits of hardware or instructions in the form of software in the processor. The above processor can be a general-purpose processor, DSP, ASIC, FPGA or other programmable logic device, discrete gate or transistor logic device, or discrete hardware component. Each method, step and logical block diagram disclosed in the embodiments of the present application can be implemented or executed. A general-purpose processor can be a microprocessor, or the processor can be any conventional processor, etc. The steps in the methods disclosed in combination with the embodiments of the present application can be directly implemented by a hardware decoding processor, or implemented by a combination of hardware and software modules in a decoding processor. The software modules can be located in a random access memory, a flash memory, a read-only memory, a programmable read-only memory or an electrically erasable programmable memory, a register and other mature storage media in the art. The storage medium is located in the memory, and the processor reads information in the memory and completes the steps in the above methods in collaboration with its hardware.

In an embodiment of the present application is also provided a computer-readable storage medium, for storing program codes which are used to execute any one implementation mode of the methods in all the foregoing embodiments.

When elements of all the embodiments of the present application are introduced, the articles “a”, “an”, “this” and “the (said)” each are intended to mean that there are one or more elements. The words “comprising”, “including” and “having” each are inclusive and mean that there can be other elements in addition to the listed elements.

It should be noted that, those skilled in the art can understand that all or part of the processes in the above method embodiments can be implemented by instructing relevant hardware through computer programs. The programs can be stored in a computer-readable storage medium, when the programs are executed, the processes of the above method embodiments can be included. The storage medium can be a magnetic disk, an optical disk, a read-only memory (ROM) or a random access memory (RAM), etc.

Each embodiment in the specification is described in a progressive manner. The same and similar parts between the various embodiments can be referred to by each other. Each embodiment focuses on its differences from other embodiments. In particular, device embodiments are relatively simply described, since they are basically similar to the method embodiments, and for relevant details, refer to partial descriptions of the method embodiments. The device embodiments described above are only illustrative, and the units and modules described as separate components can or cannot be physically separated. In addition, some or all of the units and modules can be selected according to actual needs to achieve purposes of the embodiment solutions. Those skilled in the art can understand and implement them, without creative labor made.

The above are only specific embodiments of the present application. It should be noted that without departing from the principles of the present application, those skilled in the art can also make several improvements and modifications, which can also should be regarded as being within the protection scope of the present application.

1. An interaction method, comprising:
receiving an object adding operation triggered by a first user in a session interface, wherein the session interface is an interface where the first user has a conversation with one or more second users; and
adding a first object in the session interface according to the object adding operation, wherein the first object is used to be accessed by the one or more second users.

2. The method according to claim 1, wherein the adding a first object in the session interface according to the object adding operation, comprises:
adding a label of the first object in the session interface according to the object adding operation,
wherein the first object is opened when the label of the first object is triggered.

3. (canceled)

4. The method according to claim 1, wherein the adding a first object in the session interface according to the object adding operation, comprises:
displaying at least one candidate object according to the object adding operation, wherein the at least one candidate object includes the first object; and
adding the first object in the session interface, in response to receiving a selection operation to the first object by the first user.

5. The method according to claim 1, wherein the adding a first object in the session interface according to the object adding operation, comprises:
obtaining information about the first object input by the first user, according to the object adding operation; and
obtaining the first object according to the information about the first object, and adding the first object in the session interface, wherein the information about the first object comprises one or more selected from the group consisting of:
a name for the first object, a link to the first object, and a name for an owner of the first object.

6. The method according to claim 1, further comprising:
receiving an access operation by the first user of a label of a second object in the session interface, wherein the second object is an object which is added in the session interface by the second users; and
displaying the second object according to the access operation.

7. The method according to claim 1, wherein after the receiving an object adding operation triggered by a first user in a session interface, the method further comprises:
sending the first object to the one or more second users through the session interface.

8. The method according to claim 7, further comprising:
receiving a withdrawal operation by the first user against the first object that has been sent; and
deleting the first object added in the session interface according to the withdrawal operation.

9. The method according to claim 1, further comprising:
receiving a triggering operation by the first user to a deletion control of the first object, wherein the deletion control is used for deleting the first object; and
deleting the first object according to the triggering operation.

10. (canceled)

11. The method according to claim 1, wherein before the adding a first object in the session interface according to the object adding operation, the method further comprises:
receiving a management interface display operation triggered by the first user; and
displaying an object management interface according to the management interface display operation, wherein the object management interface includes a plurality of objects that have been added and exclude the first object; or
after the adding a first object in the session interface according to the object adding operation, the method further comprises:
receiving a management interface display operation triggered by the first user; and
displaying an object management interface according to the management interface display operation, wherein the object management interface includes a plurality of objects that have been added and include the first object.

12. The method according to claim 11, further comprising:
receiving a sequencing operation of the plurality of objects triggered by the first user; and
sequencing the plurality of objects according to the sequencing operation.

13. The method according to claim 11, wherein the plurality of objects include a third object, and the method further comprises:
in response to the third object being deleted by the second user, receiving an access operation of the third object by the first user; and
displaying the third object according to the access operation.

14. The method according to claim 1, further comprising:
generating a notification message and send the notification message to the session interface, wherein the notification message is used to remind the first user and/or the second user that the first object has been added in the session interface.

15. The method according to claim 1, further comprising:
receiving a modification operation by the first user to an access permission for the first object; and
determining the access permission for the first object according to the modification operation, wherein the access permission is a permission for the second user to access the first object.

16. The method according to claim 2, wherein the first object is a cloud file or a local file, and the label of the first object includes a title of the cloud file or local file.

17. An interaction method, comprising:
receiving a sending operation of a first user sending a first object to one or more second users in a session interface, wherein the session interface is an interface where the first user has a conversation with one or more second users; and
adding the first object in an object folder label of the session interface according to the sending operation.

18. The method according to claim 17, wherein the adding the first object in an object folder label of the session interface according to the sending operation, comprises:
adding an object folder label in the session interface according to the sending operation; and
adding the first object to the object folder label.

19. The method according to claim 17, further comprising:
receiving a display operation triggered by the first user for the object folder label; and
displaying an object interface according to the display operation, wherein the object interface includes the first object.

20. The method according to claim 19, wherein the object interface includes a jump control of the first object; and
the method further comprises:
receiving a triggering operation to the jump control by the first user; and
jumping to a position of the first object in the conversation according to the triggering operation.

21. The method according to claim 17; wherein the session interface is a meeting group interface; the object folder includes a cloud document folder; and the first object includes meeting minutes.

22. The method according to claim 17; wherein the first object is a cloud file or a local file.

23. The method according to claim 17; wherein the object folder label is located at a top of a message display area in the session interface.

24. The method according to any one of claims 17-23; wherein the session interface does not include one or more of secret chat interfaces and topic group interfaces.

25. An interaction device, comprising:
an object adding operation receiving unit, configured to receive an object adding operation triggered by a first user in a session interface, wherein the session interface is an interface where the first user has a conversation with one or more second users; and a first object addition unit in the session interface, configured to add a first object in the
session interface according to the object adding operation, wherein the first object is used to be accessed by the one or more second users.

26. An interaction device, comprising:
a sending operation receiving unit, configured to receive a sending operation of a first user sending a first object to one or more second users in a session interface, wherein the session interface is an interface where the first user has a conversation with one or more second users, and
a first object addition unit in an object folder label, configured to add the first object in the object folder label of the session interface according to the sending operation.

27. An interaction equipment, comprising: a processor and a memory,
wherein the memory is configured to store instructions; and
the processor is configured to execute the instructions in the memory to perform the method according to claim 1.

28. A computer-readable storage medium, comprising instructions, wherein when the instructions are executed in a computer, the computer is enabled to execute the method according to claim 1.
